(19) United States
(12) Patent Application Publication
(10) Pub. No.: US 2023/0111857 A1
(43) Pub. Date: Apr. 13, 2023

(54) MOUNTING DEVICE FOR A DISPLAY PROTECTOR

(71) Applicant: E.V.I. GmbH, Neuried (DE)

(72) Inventors: Ulrich Kopp, Neuried (DE); Markus Vogtmann, Neuried (DE)

(21) Appl. No.: 18/080,651

(22) Filed: Dec. 13, 2022

Related U.S. Application Data
(63) Continuation of application No. PCT/EP2021/084931, filed on Dec. 9, 2021.

(30) Foreign Application Priority Data
Dec. 18, 2020 (DE) 102020134159.8

(51) Int. Cl. B29C 63/02; G06F 1/16

(52) U.S. Cl. CPC B29C 63/02; G06F 1/1626; G06F 1/1656; B29C 2063/0008

(57) ABSTRACT

A mounting device for joining a display protector onto a display of an apparatus includes a frame having an alignment cut-out which provides at least one alignment portion serving to align the display protector and, to this end, being contactable with the display protector, and at least one cut-out providing an accommodating portion. Further, the frame includes a supporting member engageable with the accommodating portion with an engaging portion, so that the supporting member projects toward the one side. In addition, the supporting member includes at least one display alignment portion which is aligned with respect to the alignment portion when the at least one supporting member is engaged with the frame, and which serves to align a display or the apparatus.

### CROSS REFERENCE TO RELATED APPLICATIONS

This application is a continuation of International Patent Application No. PCT/EP2021/084931, filed Dec. 9, 2021, which claims the benefit of German Patent Application No. DE 102020134159.8, filed Dec. 18, 2020, both of which are incorporated herein by reference.

### TECHNICAL FIELD

The present disclosure relates to a mounting device for a display protector.

### BACKGROUND

In the prior art, a mounting device for a display protector is used, to enable a user to attach (join) the display protector with high positional accuracy to a display of an apparatus.

### SUMMARY

It is an object of the invention to provide a mounting device for a display protector that enables an improved joining with high precision. In addition, the mounting device is to be manufacturable in a resource-saving manner. The precise positioning of the display protector on the display is particularly important because of the cut-outs, provided in the display protector, for sensors, cameras and speakers, for example.

An example mounting device for joining a display protector onto a display of an apparatus includes a frame which is configured such that the display protector on one side and the apparatus having the display on the other side can be positioned with respect to the frame such that the frame touches the display protector and the display and/or the apparatus during the joining. The frame includes cut-outs. At least one cutout is an alignment cut-out which includes at least one alignment portion serving to align the display protector and, to this end, being contactable with the display protector. Further, at least one cut-out is an accommodating portion. Furthermore, the frame includes a supporting member engageable with the accommodating portion by means of an engaging portion, so that the supporting member projects toward the one side. Further, the supporting member includes at least one display alignment portion which is aligned with respect to the alignment portion when the at least one supporting member is engaged with the frame, and which serves to align a display or the apparatus and, to this end, is contactable with the display or the apparatus.

Another example mounting device for joining a display protector onto a display of an apparatus includes a frame which is configured such that the display protector on one side and the apparatus having the display on the other side can be positioned with respect to the frame such that the frame touches the display protector and the display and/or the apparatus during the joining. The frame includes cut-outs. At least one cut-out is an alignment cut-out which includes a display alignment portion aligned with respect to an alignment portion, when at least one supporting member is engaged with the frame and serving to align the display or the apparatus and, to this end, being contactable with the display or the apparatus. Further, at least one cut-out is an accommodating portion. Furthermore, the frame includes the supporting member engageable with the accommodating portion by means of an engaging portion, so that the supporting member projects toward the one side. Further, the supporting member includes an alignment portion which serves to align the display protector and, to this end, is contactable with the display protector.

An apparatus may be, for example, a phone, smartphone, tablet, or e-book reader. The apparatus includes a display. For example, the display is an LCD or OLEO screen of a smartphone, including the conventional glazing of the display.

A display normal direction is a direction perpendicular to the display when the apparatus is positioned with, the frame. A longitudinal direction is a direction in which the apparatus has the greatest extension and is perpendicular to the display normal direction. A transverse direction is perpendicular to the longitudinal direction and the display normal direction. The longitudinal direction and the transverse direction span a joining plane in which the display and the display protector contact each other during the joining. The joining plane thus lies on the display surface when the apparatus is positioned with the frame.

For example, the display protector and the apparatus can be insertable into the mounting device from different sides. For example, the apparatus can be inserted into the mounting device from below in the display normal direction, and the display protector from above. In other words, in this case, the mounting device can be placed onto the apparatus or the display in the display normal direction and the display protector can then be subsequently inserted into the mounting device.

Thus, the display is positioned by means of the display alignment portion. In other words, the mounting device is positioned relative to the display by means of the display alignment portion. The display protector is positioned by means of the alignment portion.

Alternatively, the display protector and the apparatus can be inserted from one side. For example, the frame can expose at least the apparatus on one side in the longitudinal direction. Thus, the apparatus can be inserted into the mounting device from this side in the longitudinal direction, and also the display protector can be placed against the alignment portion from this side in the longitudinal direction and thus be inserted into the mounting device.

For example, the at least one alignment portion can be configured such that the alignment cut-out is large enough to allow the apparatus to pass through the alignment cut-out in an orientation tilted about the transverse direction with respect to the joining plane. When a major part of the apparatus is threaded through the alignment cutout, the display can be aligned by tilting it back into the joining plane and thus be positioned with the mounting device for a joining.

When the apparatus or the display and the display protector have their alignment for joining, they are in contact with the mounting device on different sides. Locations where the apparatus or the display are in contact with the mounting device are referred to as alignment portion. Locations where the display protector is in contact with the mounting device are referred to as display alignment portion.

Alignment portions and display alignment portions are arranged in the mounting device so as to position the display protector relative to the apparatus or the display during the joining. This enables a high positional accuracy of the display protector on the display.

The frame represents a central component to which display alignment portions are preferably either directly connected or even integrated therein. Thus, the number of transfer points between the portions that position the display and the portions that position the display protector is reduced as far as possible and tolerance chains are minimized. This ensures a high positioning accuracy.

Display alignment portions and alignment portions are preferably either integrated into the frame or into supporting members. The supporting members can be coupled to the frame via coupling areas. A coupling area is characterized in that an engaging portion is present in the supporting member and an accommodating portion is present in a corresponding area in the frame. The accommodating portion fits perfectly with the engaging portion so that the supporting member can be attached to the frame, for example by means of clamping or gluing.

A supporting, member can serve to align a display but can also serve to align a display protector. A supporting member engaged with the frame can extend to a bottom side in the display normal direction of the joining plane. Further, an alignment cutout in the mounting device can be larger than the display protector joined onto the display, viewed from the display normal direction.

The display protector can be positioned in the longitudinal direction by means of the alignment portion, wherein the display protector can be tilted with respect to the joining plane. For joining, the display protector is tilted back into the joining plane.

For example, the display protector can have a greater extension in the longitudinal direction than in the transverse direction. The width of the cut-out in the transverse direction can then be greater than a width of the display protector in the transverse direction. However, a width of the alignment cut-out in the longitudinal direction can also be greater than a width of the display protector. In this case, another alignment portion or an alignment cut-out is provided in an axis.

Thus, it is possible to join the display protector to the apparatus without abutting on the frame in the width of the display protector. Thus, a joining of the display protector with high precision or positional accuracy is possible.

Furthermore, the mounting device can have a plurality of alignment portions. This makes it possible to align the display protector with respect to a plurality of directions. For example, an alignment portion can be provided in the longitudinal direction, and an alignment portion in the transverse direction. Then, the display protector can be clearly positioned in the joining plane relative to the display with high precision.

However, also further alignment portions can be provided. If, for example, a further alignment portion is positioned centrally on the first alignment portion and the display protector has a cut-out at a specific location, the user can refer to this further alignment portion as orientation before positioning the display protector on the first alignment portion for a joining and putting it into the joining plane. This simplifies the positioning of the display protector and allows the user to join the display protector and the display with higher precision. Furthermore, alignment portions can be connected via an alignment connecting region in the mounting device. By having the alignment portions connected to each other, the positioning relative to each other is ensured. A displacement of the alignment portions relative to one another is thus prevented. Thus, joining can be performed with higher precision.

For example, alignment portions can be arcuate or part-circular, but also elliptical or otherwise connected to each other. Further, the mounting device can have a plurality of supporting members.

This is advantageous in that the display or the display protector can be aligned at a plurality of locations without the need for a supporting member to extend very far. As a result, the required construction material can be reduced. Thus, the mounting device can be manufactured in a cost-effective, resource-saving and economical manner.

For example, one supporting member can be arranged in the longitudinal direction, and one supporting member in the transverse direction, Thus, the display or display the protector can be precisely positioned in the joining plane and a twisting or shifting parallel to the joining plane can be prevented. In addition, the supporting members do not have to extend far in the joining plane. For example, a pin-shaped supporting member with a small diameter is already effective. As a result, little construction material is required.

In addition, the number of supporting members can vary and can be based, for example, on the size of the apparatus or of the display. For example, large apparatuses can have a plurality of supporting members on at least one side in the longitudinal or the transverse direction. This enables a precise joining even for large apparatuses or displays.

Furthermore, in the mounting device, supporting members can be connected to each other via a supporting connection region. This is advantageous in that the supporting members support each other. In addition to the coupling area, the supporting members mutually stabilize their positions. This ensures that the positioning of the alignment portions or the display alignment portions is maintained with respect to each other during the joining. This enables a high precision joining.

Furthermore, in the mounting device, the supporting connection region can consist of engaging portions of connected supporting members. Thus, supporting members can be connected to each other in a simple manner. This makes it easier for the user to handle the mounting device.

For example, supporting members can be interlocked by means of projections and corresponding cut-outs. Supporting connection regions can also be characterized by an adhesive film or an adhesive layer, by means of which supporting members are connected to one another. Further, relative to the apparatus or the display protector positioned with the mounting device, the mounting device can have at least one display alignment portion or one alignment portion on both sides in a longitudinal direction, and on both sides in a transverse direction.

A display alignment portion or an alignment portion can be provided in supporting members, respectively. As a result, supporting members do not have to be designed that large so as to be able to provide a display alignment portion or an alignment portion at different positions. As a result, the mounting device can be manufactured with low material requirements in a resource-saving and economical manner.

A plurality of display alignment portions or alignment portions can be provided at different locations in a supporting member. Thus, the number of necessary supporting members can be reduced, and the mounting device can be manufactured in a more resource-saving and economical manner.

Further, the frame of the mounting device can have a plate form and the one side can be a plate upper side, and the other side a plate bottom side. The plate form allows manufacturing the frame of the mounting device without an elaborate mold, such as that required for plastic die casting. This reduces the manufacturing cost. For example, cardboard, MDF, HDF, plywood, etc., or a mix of materials can be considered as material for a plate-form blank. Biodegradable, renewable or recyclable raw materials can be used. All stable flat materials are suitable.

The surface of the frame and the blank can have steps or waves or another surface structure; it can have a uniform thickness, or it can have regionally different thicknesses. Such elements of the surface structure can be used, for example, as a cutout. Moreover, such a surface structure can make it easier for the user to grip the frame, thus improving the handling of the mounting device.

For example, a thickness for the plate form can be in the range of 0.8 mm and 5 mm, preferably between 1.5 and 2.5 mm. The thickness of the material can depend on the material properties. For example, high-strength materials can be made thinner and low-strength materials are more likely to be made thicker. This allows for ease of manufacture. For example, less energy is required to manufacture the frame by means of laser cutting if the thickness of the blank is reduced. Thus, the frame can be manufactured in a cost-effective, energy-efficient, economical, and ecological manner.

Besides, it can thus be ensured that the mounting device has sufficient rigidity so that relevant alignment portions and display alignment portions remain positioned relative to each other during the joining. This enables a high precision joining.

In addition, a plate-form design has the advantage that the frames have a small space requirement, which can reduce transportation and storage costs for a manufacturer, for example. In addition, the plate form allows the mounting devices to be manufactured so that they are lightweight. This can reduce transportation costs and a resulting environmental impact. The frame can be provided to the user as a kit or as a fully assembled frame.

Further, the mounting device can include a supporting portion on the plate bottom side or in supporting members such that the mounting device positioned with the apparatus is supported on the display or on the apparatus, wherein the supporting portion forms the joining plane. This allows the mounting device to be clearly positioned with respect to the display in all directions, the longitudinal direction, the transverse direction and the display normal direction. This enables joining with high precision.

A plurality of supporting portions can also be formed on the plate bottom side at different positions. In this way, an alignment of the mounting device to the display can be precisely adjusted.

If the supporting portions are far apart, this provides stability to the mounting device and can prevent the mounting device from moving relative to the display during the joining. A plurality of supporting portions can also be connected to each other over a large area.

The bottom side of the plate-shaped frame can be used as a supporting portion. As a result, this supporting portion does not have to be manufactured separately and the manufacturing cost of the mounting device, can be reduced. Further, cut-outs of the mounting device can extend from the one side to the other side.

As a result, manufacturing methods for the frame include stamping, laser cutting, or water jet cutting, for example. This reduces the manufacturing cost, while the mounting device can be manufactured with high precision. This enables a precise joining of the display protector and the display.

Furthermore, in the mounting device, the display of the apparatus positioned with the mounting device can serve as an additional alignment portion to the display protector. Thus, in the mounting device, an alignment portion that positions the display protector in the display normal direction can be omitted. This reduces the manufacturing cost of the mounting device.

If the apparatus is already positioned with the mounting device, the display protector can, for example, first be brought into contact with the display, i.e. the additional alignment portion, in an alignment tilted relative to the joining plane. Subsequently, the display protector can be brought into contact with, for example, an alignment portion for alignment in the longitudinal direction. Subsequently, the display protector can be brought into contact, for example, with an alignment portion for an alignment in the transverse direction. As the display protector is already positioned in the display normal direction before the display protector is positioned in the longitudinal and transverse directions, the alignment portions for a positioning in the longitudinal and transverse directions can have a small extension in the display normal direction. In other words, the plate form can be designed to be very thin, and the mounting device can still achieve its object. This reduces the material required for manufacturing, the weight, and the space required for the mounting device.

Furthermore, alignment cut-out or supporting members, as viewed from the display normal direction, can have a contour of the display protector having an offset outwardly in parallel to the joining plane. When supporting members have alignment portions for aligning the display protector, the supporting members can have the offset. When the alignment cut-out has alignment portions for aligning the display protector, the alignment cut-out can have the offset.

The offset serves to ensure that the display protector is not prevented from moving by an alignment portion during the joining. For example, in a case in which an alignment portion is arranged in the longitudinal direction and an alignment portion is arranged on each side of the display protector in the transverse direction, it is desirable for joining the display protector that these alignment portions arranged in the transverse direction have a distance large enough for the display protector to pass freely between the alignment portions when viewed in the display normal direction.

In a case in which the alignment portion is a closed alignment portion surrounding the display protector, an entire circumferential contour of the display protector is reproduced in the alignment portion by means of the offset. Further, concave radii of a contour of alignment portions of the mounting device can be configured to be smaller than corresponding convex radii of the display protector and can serve as alignment connecting regions. This can impede the display protector from being prevented from moving during the joining. Thus, a precise joining is made possible. In addition, tolerances regarding the position and the shape of the concave radii are allowed for the manufacture. This reduces the manufacturing cost.

For example, a circumferential contour of a display protector in the joining plane can have four corners and can otherwise consist of straight edges. The edges can be rounded by means of radii and can form corner radii. When the display protector is aligned by means of the alignment cut-out of the frame, the corresponding corner radii in the alignment cut-out of the frame are designed to be smaller than the corner radii of the display protector.

Furthermore, in the mounting device, a central plate arranged in parallel to the joining plane within the alignment cut-out can be connected to the frame via webs so that weakened areas are created around the central plate. This allows the frame to be easily provided by the consumer itself. All that is required is to detach the central plate from the frame. As long as the central plate is not detached from the frame, it provides rigidity to the frame. For example, during transport, the frame is thus better protected against damage.

The weakened area prevents the frame itself from being damaged when the central plate is detached from the frame. This results in less waste for the user and the number of manufactured mounting devices can be reduced. Thus, the mounting device can be manufactured in a resource-saving manner.

A central plate can be connected to the frame by one or a plurality of webs. The width of the webs is preferably 0.1 mm to 1 mm. The width of the webs is preferably configured such that the central plate can be detached from the frame by manual force. In so far, the width of the webs strongly depends on the material of the blank, on the thickness of the blank and on the number of webs by which the central part is connected to the frame.

The weakened area can also be a circumferential web without gaps, which is correspondingly thin, much thinner than the thickness of the blank. Further, in the mounting device, the central plate can include the supporting members which are bonded to the central plate by means of a weakened area via, webs. This causes a recycling of material that would otherwise be scrap material. Thus, the mounting device is manufactured in a resource-saving, ecological and cost-effective manner. Furthermore, material consumption and space requirements are reduced. This also reduces storage requirements.

Supporting members can also be connected, outside the frame in a scrap material, to the scrap material by means of webs, for example if the supporting members required are so many or so large that they cannot be accommodated within the central plate. Furthermore, in the mounting device, the webs can be implemented in the concave radii of alignment cut-outs.

When elements are detached from the frame or the central part, i.e., when the webs are severed, this can lead to inaccurate crack and fracture structures. These structures can impair the joining. In addition, material particles such as paper particles can be detached from the structures. These material particles can accumulate on the side of the display protector that comes into contact with the display if the webs are positioned unfavorably. If material particles are trapped between the display and the display protector during the joining, this can lead to bubbles and non-adherent areas between the display and the display protector.

If the concave radii of alignment cut-outs are designed to be smaller than the corresponding convex radii of the display protector, then the distance from the alignment cut-out to the display protector increases from the beginning of a concave radius toward its middle region. In the middle region of the radius, the distance between the alignment cut-out and the display protector is greatest. A web can be arranged in this region. This is advantageous in that a base of the web in the alignment portion is as far away as possible from the display protector. If a remainder of the web is left on the alignment portion when the central plate is detached, this does not interfere with the movement of the display protector during the joining. In addition, inclusions can be avoided, and a high precision joining is enabled. Preferably, a base of the web in the central plate is also outside the contour of the display protector as viewed from a display normal direction. Preferably, the bases of the web are not arranged in the alignment portions or the display alignment portions.

Further, in the mounting device, the alignment cut-out can include additional cut-outs which substantially extend outwardly from the alignment cut-out in parallel to the joining plane and at the ends of which the webs are located. For example, these additional cut-outs can extend outwardly away from the display protector in a flat or smooth V-shape such that a peak of the V-shape forms an area where the distance between the alignment cut-out or the additional cut-out to the display protector is larger than in the remaining areas of the V-shape. In this context, “smooth” means that the V-shape forms a large obtuse angle with a plane alignment portion or a display alignment portion.

A V-shape can preferably recede 0.3-1.0 mm outwardly from the alignment cut-out. This prevents the display protector from getting caught in the V-shape area during the joining. This makes handling easier for the user and joining is possible with high precision.

The shape of the recess can also be curved, for example. Furthermore, in the mounting device, the additional cut-outs can be used as accommodating portions with which the engaging portions of the supporting members can be engaged.

In this alternative shape of the recess, the recess is significantly larger than in a V-shape, for example in a range of 5 mm or more, so that the recess can be used as an accommodating portion for an engaging portion of supporting members. In this case, the recess can have a shape adapted to that of the engaging portion. In this case, the webs can be positioned at the locations of the recess that are furthest from the display protector or the display.

Further, in the mounting device, the central plate can have a smoothing-out member provided in the central plate by means of a weakened area via webs and having a plane surface at least on one side in the transverse direction or the longitudinal direction. The smoothing-out member serves to sweep over the display protector with the straight edge under the action of pressure after joining the display protector. In this way, any air bubbles trapped between the display protector and the display are removed. This improves the handling of the display protector for the user. In addition, material that would otherwise be scrap material is thus used. Hence, an additional manufacture of smoothing-out members can be omitted. The mounting device thus helps to save resources.

The shape of the smoothing-out member can, for example, be substantially square or rectangular. This is advantageous in that partially already existing weakened areas can be used for detaching the smoothing-out member from the central plate. In this way, the mounting device can be manufactured in a cost-effective manner. For all elements that are detached from the alignment cut-out, the central plate, the alignment element or scrap material outside the frame, weakened areas can be used for a plurality of elements, thus saving manufacturing cost.

For example, the shape of the smoothing-out member can also be substantially triangular. In this case, the user grips the smoothing-out member at one corner and uses the opposite edge for smoothing out. If the corner that the user grips is central relative to the opposite edge, such as in an isosceles triangle, this is advantageous in that the force applied by the user to the smoothing-out member is transmitted evenly to the opposite edge. This makes it easier for the user to handle the smoothing-out member, and bubble formation between the display protector and the display can be effectively prevented. Thus, joining with high precision is possible.

Furthermore, in the mounting device, the smoothing-out member can include the supporting members which are bonded to the smoothing-out member by means of a weakened area via webs. This makes it possible to design the smoothing-out member as large as possible. For example, the smoothing-out member can have a width corresponding to the width of a display protector. This allows the entire display protector to be treated with a wiping-off movement transverse to the width in such a way that air bubbles trapped between the display and the display protector are removed.

The smoothing-out member can also include individual supporting members only. Further, in the mounting device, the smoothing-out member can be positioned to cover an area of the apparatus projecting contrary to the display normal direction on a bottom side of the apparatus, as viewed from the display normal direction when the apparatus is positioned with the mounting device.

Such an area projecting contrary to the display normal direction on the bottom side of the apparatus can be, for example, a camera lens or a camera unit of the apparatus. If the apparatus is placed on its bottom side and the mounting device is placed onto the apparatus, the apparatus may lie unstably and tilt with respect to a ground surface during joining. Thus, the joining plane can tilt during a joining, which significantly interferes with high precision joining.

When the smoothing-out member is appropriately positioned, the central plate can, after at least the smoothing-out member is detached, be positioned such that a bottom side of the apparatus rests flat on the central plate, wherein the projecting portions project into the cut-out, created by detaching the smoothing-out member, of the central plate. Thus, a tilting of the joining plane can be effectively prevented. The apparatus positioned with the mounting device then rests stably on the ground surface, and a high precision joining is made possible.

The central plate, which is positioned on the bottom side of the apparatus apart from the camera area can have the outer contour of the display protector, when viewed from the display normal direction. The thickness of the central plate can be selected to be larger than the amount by which the projecting region projects from the bottom side of the apparatus.

Further, in the mounting device, the supporting members can be configured such that, in the display normal direction, lower ends of the supporting members do not project further than a bottom side of the apparatus or a bottom side of the central plate when the apparatus is positioned with the mounting device and the supporting members are engaged with the frame. This ensures that the supporting members are not in contact with the surface on which the apparatus or the central plate is placed in order to position the apparatus with the mounting device and join the display protector. This means that the support portion or alignment portion of the mounting device does not lose contact with the display or the apparatus when the mounting device with the apparatus and the central plate, if any, is positioned on a substantially plane surface for a joining. In other words, no gap is produced between the alignment portion and, the display or the apparatus. Thus, when positioned, the display protector is prevented from slipping past an alignment portion into such a gap, thus taking an undesired position relative to the display. This enables high precision joining.

Further, in the mounting device, the central plate can include at least one apparatus holding member which is provided in the central plate by means of a weakened area via webs and by means of which the apparatus can be held. Thus, residual material is used to provide an apparatus holding member. This eliminates the need to manufacture a separate apparatus holding member and the mounting device helps to save resources.

By means of the apparatus holding member, the apparatus can be placed on a ground surface in such a way that a user in front of whom the apparatus is placed can clearly see the display without having to hold the apparatus itself. For example, the apparatus holding member can serve to hold the apparatus on a plane ground surface at a certain angle relative to the surface. For example, this angle is in the range of 50° to 80°. In this angle range, the apparatus inserted in the apparatus holding member takes an orientation which is ergonomic with respect to the user's viewing direction.

Furthermore, in the mounting device, a display alignment portion can have operating element cut-outs which expose projecting regions of the apparatus or of the display in a direction parallel to the joining plane. This serves to ensure that the display alignment portions do not get caught on projecting regions of the apparatus or of the display when the mounting device is placed onto the apparatus or the display. Thus, high precision joining is made possible. Such projecting, regions can be, for example, operating keys or cover elements, for example for a headphone or a USB connection.

### BRIEF DESCRIPTION OF THE DRAWINGS

FIG. 1 shows a top view of a first embodiment of the invention in a non-assembled state.

FIG. 2 shows an isometric view of the first embodiment of the invention in an assembled state.

FIG. 3 shows a top view of a second embodiment of the invention.

FIG. 4 shows a top view of a third embodiment of the invention.

FIG. 5 shows a top view of a fourth embodiment of the invention.

FIG. 6 shows a top view of a fifth embodiment of the invention.

### DETAILED DESCRIPTION OF THE PREFERRED EMBODIMENT(S)

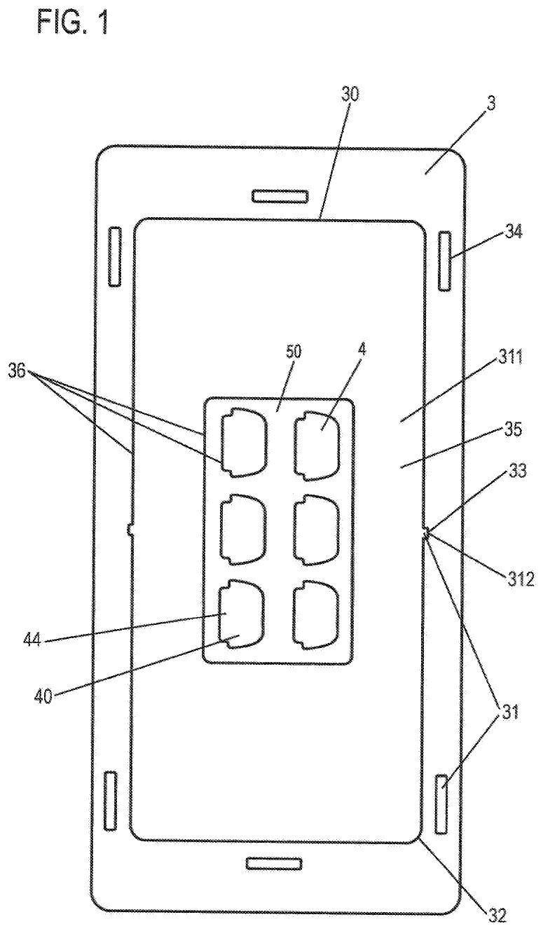

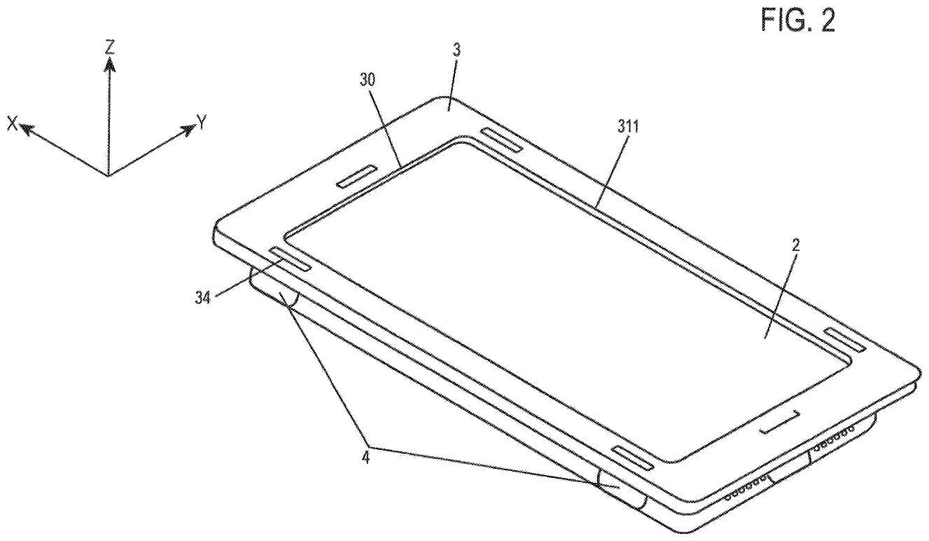

FIG. 1 shows a top view, viewed from the display normal direction Z, of a first embodiment of the invention. See, in FIG. 2, an illustration of X, Y, and Z directions with respect to a frame 3. In this embodiment, the frame 3 has six accommodating portions 34. One accommodating portion 34 is arranged centrally in the longitudinal direction X on each side of the alignment cut-out 311. Two accommodating portions 34 are arranged in the transverse direction Y on each side of the alignment cut-out, at a very large distance from one another in the longitudinal direction, respectively. This is advantageous in that a torque between the display and the mounting device in the joining plane XY can be very well supported by the supporting members 4. The frame 3 has a rectangular outer contour, wherein outer corners are rounded.

The frame 3 has a rectangular alignment cut-out 311, the corners of the cutout in the display normal direction Z being rounded. The rounded corners represent alignment connecting regions 32. The straight portions connected to the rounded corners represent the alignment portions 30. The alignment portions 30 and the alignment connecting regions 32 represent an offset of a contour of a display protector 1. That is, a display protector viewed from the display normal direction Z has a smaller area than the alignment cut-out 311.

On each side of the alignment cut-out 311 in the transverse direction Y, an additional cut-out 312 is arranged to enlarge the alignment cut-out 311, as viewed from the display normal direction Z and serves as a recess. In the present embodiment, this recess has a depth of 0.5 mm. The recess can also recede smoothly from alignment portions 30, for example at a very obtuse angle or in a curved shape.

A central plate 35 is disposed within the alignment cut-out 311 and is bonded to the frame 3 by means of a weakened area. The weakened area is a circumferential continuous section interrupted only at webs 33. The webs 33 are located in the edges of the additional cut-outs 312 furthest away in the transverse direction Y.

In the region of the additional cut-outs 312, the central plate 35 projects outwardly in the transverse direction Y with its edge outermost in the transverse direction Y beyond the alignment portions 30 which are aligned in the longitudinal direction X. In other words, the webs 33 from the additional cut-outs 312 do not project inwardly in the transverse direction beyond the alignment portions 30 arranged in the longitudinal direction. This is advantageous in that the webs 33 do not interfere with a joining of a display protector 1, regardless of where the webs break when the central plate 35 is detached from the frame 3.

Within the central plate 35, a smoothing-out member 50 is connected to the central plate 35 by means of a weakened area. The smoothing-out member 50 can be detached from the central plate 35 by manual force. Within the smoothing-out member 50, six supporting members 4 are connected to the smoothing-out member 50 by means of a weakened area. The supporting members 4 can be detached from the smoothing-out member 50 by manual force.

The supporting members 4 each have a display alignment portion 40 and an engaging portion 44 on both sides in the display normal direction Z. This is advantageous in that, when the supporting members 4 are engaged with the accommodating portions 34 of the frame 3, there is no need to pay attention to an alignment of a display alignment portion 40, since the supporting members 4 can be inserted into the accommodating portions 34 on both sides in the transverse direction Y of the alignment cutout 311. Thus, assembling the mounting device is very easy.

Further, all six supporting members 4 are identically configured. Thus, each of the six supporting members 4 can be inserted into each of the six accommodating portions 34. Thus, an assembly of the mounting device is very easy.

The frame 3, the central plate 35, the smoothing-out member 50 and the supporting members 4 are made of the same flat plate-shaped raw material and have the same thickness in the display normal direction Z. Thus, a plurality of mounting devices can be stored in a very space-saving manner. In addition, a material requirement for manufacturing the mounting device is reduced, which lowers the manufacturing cost and contributes to a careful use of natural resources.

FIG. 2 shows an isometric view of the mounting device of the first embodiment, the additional cut-outs 312 not being shown. In FIG. 2, the central plate 35 is detached from the frame 3. The engaging portions 44 of the supporting members 4 are inserted into the accommodating portions 34 of the frame 3 contrary to the display normal direction Z and are thus engaged or connected with the frame 3. The supporting members 4 project from the frame at least contrary to the display normal direction Z.

The mounting device is placed on an apparatus having a display 2 such that display alignment portions 40 are in contact with the apparatus and the display 2 supports the mounting device in a display normal direction Z. In other words, the display 2 and the frame 3 contact each other on the lower side of the plate-shaped frame 3 in the display normal direction. The lower side of the frame 3 provides a supporting portion. The cut-outs of the accommodating portions 34 are positioned so as to be aligned with the outer contour of the apparatus when viewed from a display normal direction Z, together with the display alignment portions 40 of the supporting members 4 facing the apparatus.

When a display 2 is positioned with the mounting device, the mounting device and the display 2 are clearly positioned relative to each other in all three spatial directions of the display normal direction Z, the longitudinal direction X, and the transverse direction Y via the supporting portion and the display alignment portions 40. In particular, a displacement or a rotation of the mounting device and the display 2 relative to each other is effectively prevented.

When a display 2 is positioned with the mounting device, a display protector can be joined to the display 2. For this purpose, the display protector is tilted about the transverse direction Y with respect to the joining plane XY. One side of the circumference of the display protector 1 is then made to contact the display 2 through the alignment cut-out 311. Maintaining this contact, the side of the circumference of the display protector 1 is brought into contact with the alignment portion 30 provided in the longitudinal direction X. Then, the display protector 1 is aligned with respect to the alignment portions 30 aligned in the longitudinal direction X. Then, the display protector can be tilted into the joining plane XY while maintaining these contact points. As a result, the contact areas of the display protector 1 and the display 2 become larger. When the display protector 1 is aligned in parallel to the joining plane XY and lies flat against the display 2, the joining process is completed.

The smoothing-out member 50 can then be used to smooth out air bubbles that may have formed between the display 2 and the display protector 1 from the contact area between the display 2 and the display protector 1. For this purpose, a flat side of the circumference of the smoothing-out member 50 is placed on the display protector 1, as viewed from the display normal direction Z, in front of an air bubble, and pressure is applied to the display protector 1 by the smoothing-out member 50. Meanwhile, the smoothing-out member 50 is moved toward the air bubble. Then, when the pressure is applied appropriately, the air bubble is pushed in front of an edge of the smoothing-out member 50 until the air bubble reaches an end of the contact area between the display protector 1 and the display 2 and disappears from the contact area.

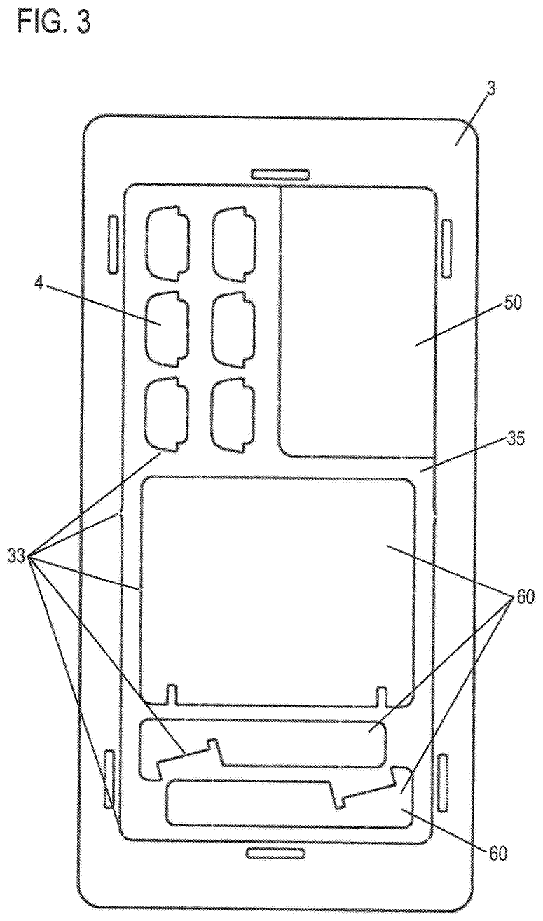

In FIG. 3, a second embodiment of the present invention is shown from the display normal direction Z. The second embodiment differs from the first embodiment in that the supporting members 4 are bonded to the central plate 35 by means of weakened areas and are no longer bonded to the smoothing-out member 50 within the smoothing-out member 50. Further, the mounting device additionally includes components for an apparatus holding member 60, which are connected to the central plate 35 by means of weakened areas within the central plate 35.

Further, the smoothing-out member 50 is disposed at a position in the outermost area of the central plate in the transverse direction Y and the longitudinal direction X. In this area, there is a camera, which represents an area projecting contrary to the display normal direction Z, in the apparatus when it is positioned with the mounting device. Thus, at least in the area in the longitudinal direction X and the transverse direction Y, the same weakened area can be used for the smoothing-out member 50 and the central plate 35 to detach the smoothing-out member 50 and the central plate 35 from the frame 3. As a result, the manufacturing cost can be reduced.

Once the smoothing-out member 50 and other members or components such as the supporting members 4 or the components for the apparatus holding member 60 are detached from the central plate 35, the central plate 35 can be positioned under the apparatus against the display normal direction Z such that the camera projects into the area from which the smoothing-out member 50 is detached from the central plate 35. Thus, the bottom side of the apparatus lies flat on the central plate 35 and the surface, the central plate 35, the display 2 and the joining plane XY are substantially parallel to each other. This is advantageous in that the apparatus with the positioned mounting device can rest stably on the surface and cannot wobble during the joining. This enables a precise joining.

The apparatus holding member 60 consists of two identical foot components and a rest component. The two foot components can be engaged with the rest component via engaging portions. When the apparatus is inserted into the apparatus holding member 60, the apparatus is held by the apparatus holding member 60 at an angle with respect to the ground surface which the rest component forms with the surface. In the present embodiment, this angle is 75°.

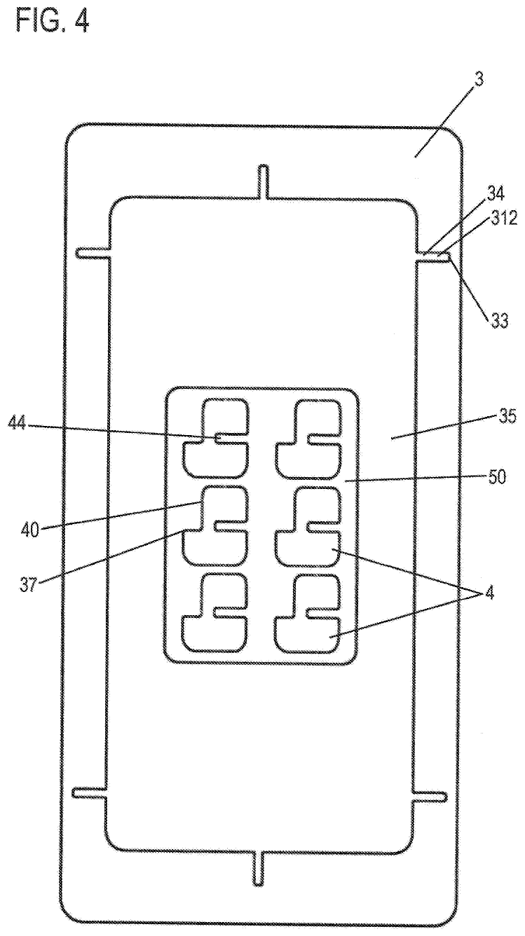

In FIG. 4, a third embodiment of the present invention is shown from the display normal direction Z. The third embodiment differs from the first embodiment in that the supporting members 4 have a different shape and the accommodating portions 34 are positioned differently. The accommodating portions 34 are arranged in the frame so as to open into the alignment cut-out 311. The accommodating portions 34 and the additional cut-outs 312 are thus identical. In other words, the accommodating portions 34 of the alignment cut-out 311 serve as additional alignment portions 312.

The webs 33 via which the central plate 35 is connected to the frame 3 are arranged in the transverse direction Y at the outermost ends of the accommodating portions 34. This can prevent residues of the web 33, after the central plate 35 has been detached from remaining in the alignment cut-out 311 required for joining the display protector 1 onto the display 2. In addition, the webs 33 are located so far away from the alignment cut-out 311 where the joining takes place that it is highly unlikely that particles from the severed web 33 get between the display protector and the display 2 during the joining.

In this embodiment, the supporting members 4 are inserted from the alignment cut-out 311 with their engaging portions 44 outwardly in the longitudinal direction X or the transverse direction Y into the accommodating portions 34 of the frame, and surfaces that can serve as supporting members 37 are aligned contrary to the display normal direction Z. When the supporting members 4 are engaged with the frame 3, the supporting members 4 project on both sides from the frame 3 in the display normal direction X.

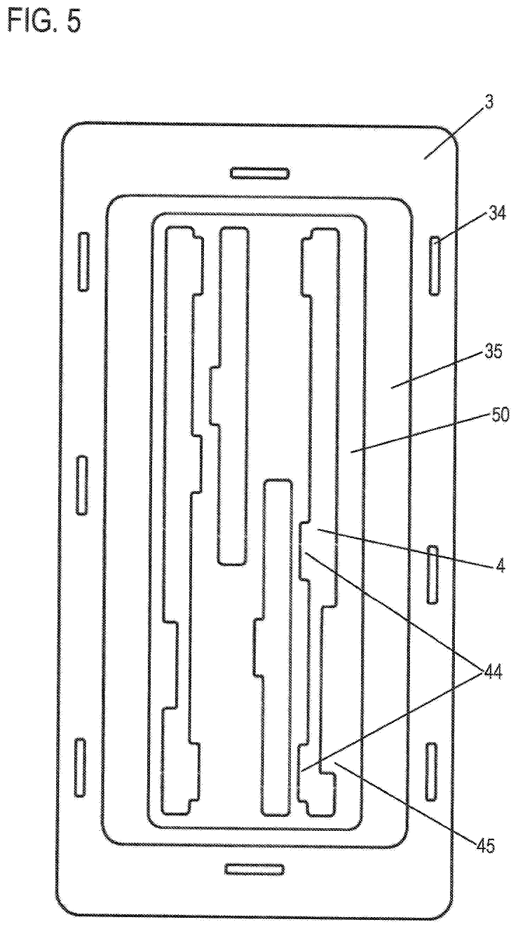

In FIG. 5, a fourth embodiment of the present invention is shown from the display normal direction Z. The fourth embodiment differs from the first embodiment in that the supporting members 4 are shaped differently and the accommodating portions 34 are provided in the frame at different positions and in different numbers.

In the present embodiment, four supporting members 4 in a smoothing-out member 50 are connected to a smoothing-out member 50 by weakened areas. The supporting members 4 differ from each other in shape. Two short supporting members 4 are provided, which are engaged with the frame 3 on both sides of the alignment cut-out 311 in the longitudinal direction X. Each short supporting member 4 has an engaging portion 44.

Two long supporting members 4 are provided, which engage with the frame 3 on both sides in the transverse direction Y. Each long supporting member 4 has three engaging portions 44. In addition, the long supporting members 4 have operating element cut-outs 45 of different shapes. The supporting members 4 are inserted with their engaging portions 44 into the accommodating portions 34, and adjacent supporting members 4 can engage with each other and can support each other.

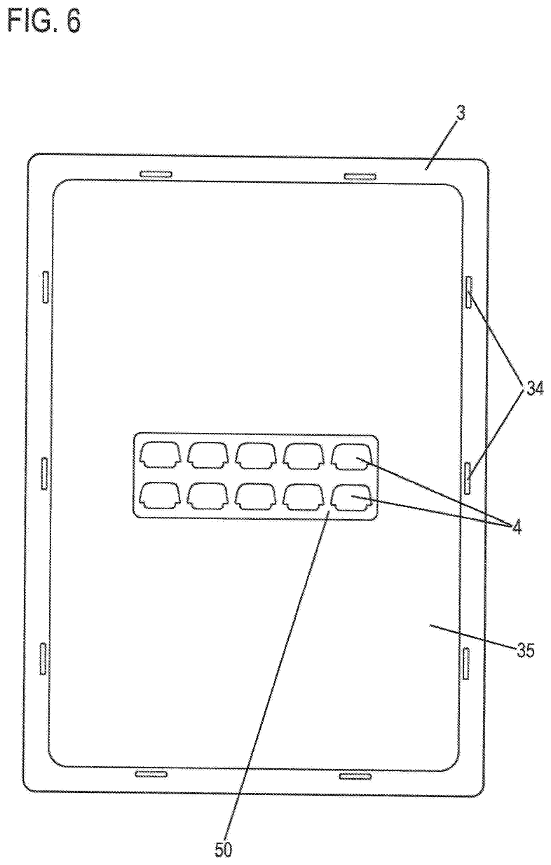

In FIG. 6, a fifth embodiment of the present invention is shown from the display normal direction Z. The fifth embodiment differs from the first embodiment in that the frame 3 is larger and more supporting members 4 and accommodating portions 34 are provided in the frame 3.

The present embodiment is a mounting device for a large apparatus, such as a tablet or a phablet. Accordingly, ten supporting members 4 are provided and 10 accommodating portions are distributed around the alignment portion 311 in the longitudinal direction X and the transverse direction Y to ensure a relative position of the display 2 and the mounting device during the joining.

What is claimed is:

1. A mounting device for joining a display protector onto a display of an apparatus comprising:
a frame which is configured such that the display protector on one side and the apparatus having the display on another side are positional with the frame such that the frame touches the display protector and the display and/or the apparatus during the joining,
the frame comprising cut-outs, wherein
at least one cut-out is an alignment cut-out which comprises at least one alignment portion serving to align the display protector and, to this end, being contactable with the display protector, and
at least one cut-out is an accommodating portion, and
a supporting member engageable with the accommodating portion by means of an engaging portion, so that the supporting member projects toward the one side,
wherein the supporting member comprises at least one display alignment portion which is aligned with respect to the alignment portion when the at least one supporting member is engaged with the frame, and which serves to align a display or the apparatus and, to this end, is contactable with the display or the apparatus.

2. The mounting device according to claim 1 wherein an alignment cut-out is larger than the display protector joined onto the display, viewed from a display normal direction (Z), which is a direction perpendicular to the display when the apparatus is positioned with the frame.

3. The mounting device according to claim 1 which comprises a plurality of alignment portions.

4. The mounting device according to claim 1 wherein alignment portions are connected via an alignment connecting region.

5. The mounting device according to claim 1 wherein the mounting device has a plurality of supporting members.

6. The mounting device according to claim 7 wherein supporting members are connected to each other via a supporting connection region.

7. The mounting device according to claim 6 wherein the supporting connection region consists of engaging portions of connected supporting members.

8. The mounting device according to claim 1 wherein, relative to the apparatus positioned with the mounting device or to the display protector, at least one display alignment portion or one alignment portion is present on both sides in a longitudinal direction (X), which is a direction in which the apparatus has the largest extension and is perpendicular to the display normal direction (Z), and is present on both sides in a transverse direction (Y), which is perpendicular to the longitudinal direction (X) and the display normal direction (Z).

9. The mounting device according to claim 1 wherein the frame has a plate form, and the one side is a plate upper side, and the other side is a plate bottom side.

10. The mounting device according to claim 9 wherein the mounting device comprises a supporting portion on the plate bottom side or in supporting members, so that the mounting device positioned with the apparatus is supported on the display or on the apparatus, wherein the supporting portion forms a joining plane (XY) in which the longitudinal direction (X) and the transverse direction (Y) are located.

11. The mounting device according to claim 9 the alignment cut-out or supporting members, viewed from the display normal direction (Z), comprising a contour of the display protector having an offset outwardly in parallel to the joining plane (XY).

12. The mounting device according to claim 11 wherein concave radii of a contour of alignment portions are configured to be smaller than corresponding convex radii of the display protector and serve as alignment connecting regions.

13. The mounting device according to claim 9 wherein a central plate which is arranged in parallel to the joining plane (XY) within the alignment cut-out is connected to the frame via webs, so that weakened areas are created around the central plate.

14. The mounting device according to claim 13 wherein the central plate comprises supporting members, which are bonded to the central plate by means of a weakened area via webs.

15. The mounting device according to claim 14 wherein the webs are implemented in the concave radii of alignment cut-outs.

16. The mounting device according to claim 14 wherein the alignment cut-out includes additional cut-outs which extend outwardly from the alignment cut-out substantially in parallel to the joining plane (XY) and at the ends of which the webs are located.

17. The mounting device according to claim 16 wherein the additional cut-outs are used as accommodating portions of the supporting members, with which the engaging portions can be engaged.

18. A mounting device for joining a display protector onto a display of an apparatus, the mounting device including:
a frame which is configured such that the display protector on one side and the apparatus having the display on another side are positional with the frame such that the frame touches the display protector and the display and/or the apparatus during the joining,
the frame comprising cut-outs, wherein
at least one cut-out is an alignment cut-out which comprises a display alignment portion aligned with respect to an alignment portion, when at least one supporting member is engaged with the frame, and serving to align the display or the apparatus and, to this end, being contactable with the display or the apparatus, and
at least one cut-out is an accommodating portion, and
the supporting member engageable with the accommodating portion by means of an engaging portion, so that the supporting member projects toward the one side,
wherein the supporting member comprises at least one alignment portion which serves to align the display protector and, to this end, is contactable with the display protector.

19. The mounting device according to claim 18 wherein the cut-outs extend from the one side to the other side.

20. The mounting device according to claim 19 wherein the display of the apparatus positioned with the mounting device serves as an additional alignment portion to the display protector.
